(19) United States
(12) Patent Application Publication
(10) Pub. No.: US 2018/0284359 A1
(43) Pub. Date: Oct. 4, 2018

(54) CONNECTION SUPPORT AND OPTICAL MODULE

(71) Applicant: FUJITSU COMPONENT LIMITED, Tokyo (JP)

(72) Inventors: Shinichiro Akieda, Tokyo (JP); Osamu Daikuhara, Tokyo (JP); Hongfei Zhang, Tokyo (JP)

(21) Appl. No.: 15/938,034

(22) Filed: Mar. 28, 2018

(30) Foreign Application Priority Data
Mar. 31, 2017 (JP) 2017-069862

(51) Int. Cl. G02B 6/38

(52) U.S. Cl. CPC G02B 6/3858

(57) ABSTRACT

A connection support part includes a support body, a cable connecting part provided at one end of the support body in a longitudinal direction thereof and configured to be mounted to an optical cable, and a ferrule connecting part provided at another end of the support body in the longitudinal direction thereof and configured to be mounted to a ferrule, wherein the cable connecting part clamps a sleeve covering the optical cable so as to be mounted to the optical cable, and the ferrule connecting part has a contact portion placed in contact with the ferrule.

### BACKGROUND OF THE INVENTION

### 1. Field of the Invention

The disclosures herein relate to a connection support and an optical module.

### 2. Description of the Related Art

Optical communications have been increasingly used for the high-speed interface of supercomputers and high-end servers. Optical communications employ optical modules for conversion between electrical signals and optical signals.

An optical module includes light emitters, photodetectors, and a driver circuit. The light emitters, the photodetectors, and the driver circuit are mounted on a printed board.

An MT (mechanical transfer) ferrule and a lens ferrule are fastened to each other with a clip. The MT ferrule is connected to an optical cable having optical fibers.

Optical fibers are covered with a tensile strength member and a cover. The optical fibers exposed from the tensile strength member are connected to the MT ferrule. The optical cables are fixedly mounted to the housing where the tensile strength member provides coverage. The tensile strength member is made of aramid fibers or the like. The cover expands and contracts in response to changes in the ambient temperature. Contraction of the cover causes the exposed portion of optical fibers to be elongated, so that the optical fibers may be bent or broken at this portion and may cause optical loss.

It may thus be desired to provide a connection support for preventing exposed optical fibers from being bent or broken.

### [Patent Document 1] Japanese Patent Application Publication No. 2015-23143

### [Patent Document 2] Japanese Patent Application Publication No. 2010-20162

[Patent Document 3] Japanese Utility Model Publication No. H5-32802

### SUMMARY OF THE INVENTION

A connection support includes a support body, a cable connecting part provided at one end of the support body in a longitudinal direction thereof and configured to be mounted to an optical cable, and a ferrule connecting part provided at another end of the support body in the longitudinal direction thereof and configured to be mounted to a ferrule, wherein the cable connecting part clamps a sleeve covering the optical cable so as to be mounted to the optical cable, and the ferrule connecting part has a contact portion placed in contact with the ferrule.

### BRIEF DESCRIPTION OF THE DRAWINGS

Other objects and further features of the present invention will be apparent from the following detailed description when read in conjunction with the accompanying drawings, in which:

FIG. 1 is an exploded perspective view of an optical module;

FIG. 2 is a drawing illustrating an optical cable coupled to an MT ferrule;

FIGS. 3A through 3F are drawings illustrating a connection support according to a first embodiment;

FIGS. 4A and 4B are perspective views of the connection support according to the first embodiment;

FIG. 5 is a perspective view of the connection support of the first embodiment mounted to the MT ferrule and the lens ferrule;

FIGS. 6A through 6C are perspective views of the connection support of the first embodiment mounted to the MT ferrule and the lens ferrule;

FIG. 7 is a perspective view of the connection support of the first embodiment mounted to the MT ferrule and the lens ferrule;

FIG. 8 is an exploded perspective view of the optical module of the first embodiment;

FIGS. 9A and 9B are perspective views of a connection support according to a second embodiment;

FIG. 10 is a perspective view of the connection support of the second embodiment mounted to the MT ferrule and the lens ferrule;

FIGS. 11A through 11C are perspective views of the connection support of the second embodiment mounted to the MT ferrule and the lens ferrule;

FIGS. 12A through 12F are drawings illustrating a connection support according to a third embodiment;

FIGS. 13A and 13B are perspective views of a connection support according to a third embodiment;

FIG. 14 is a perspective view of the connection support of the third embodiment mounted to the MT ferrule and the lens ferrule;

FIGS. 15A through 15C are perspective views of the connection support of the third embodiment mounted to the MT ferrule and the lens ferrule;

FIGS. 16A and 16B are perspective views of a connection support according to a fourth embodiment;

FIG. 17 is an perspective view of the connection support of the fourth embodiment is mounted;

FIGS. 18A through 18D are drawings illustrating a connection support according to a fifth embodiment; and

FIGS. 19A through 19D are drawings illustrating another connection support according to the fifth embodiment.

### DESCRIPTION OF THE PREFERRED EMBODIMENTS

In the following, embodiments for implementing the invention will be described. The same members are referred to by the same numerals, and a description thereof will be omitted.

### First Embodiment

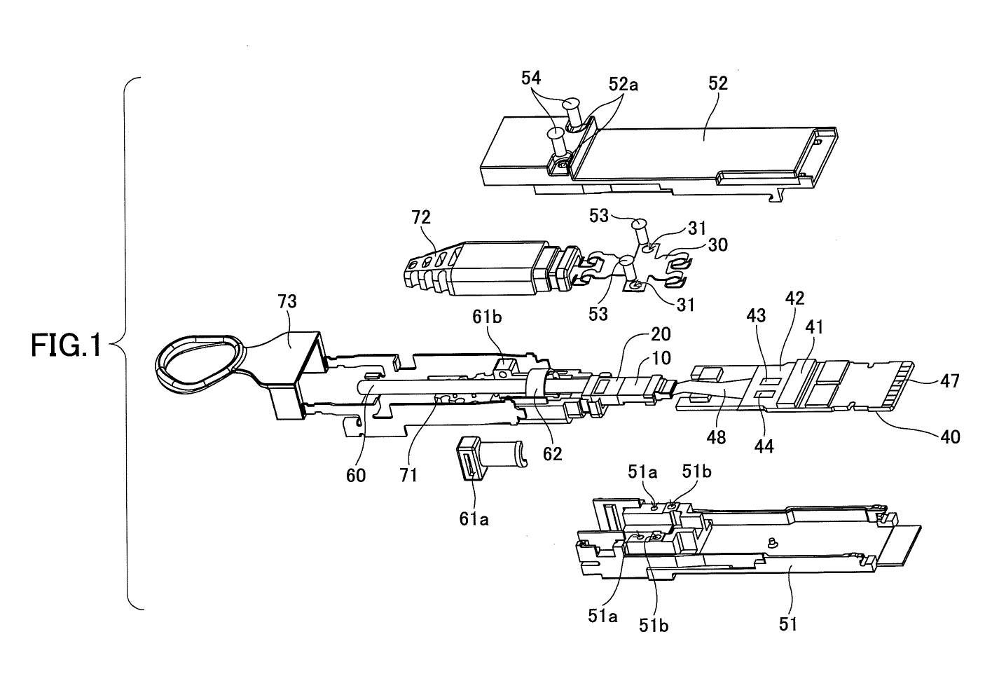

In the following, a description will be given of how the exposed portion of optical fibers in an optical module is elongated. FIG. 1 is an exploded perspective view of an optical module.

An optical module illustrated in FIG. 1 is configured such that a lens ferrule 10 and an MT ferrule 20 fastened to each other with a clip 30, a printed board 40, and an optical waveguide 48 are installed in the housing having a lower housing 51 and an upper housing 52, with an optical cable 60 attached thereto. The lens ferrule 10 and the MT ferrule 20 are aligned with each other by guide pins (not shown).

The printed board 40 has a connector 41 for connecting an FPC (flexible printed circuit) 42. The FPC 42 has light emitters 43 such as VCSELs (vertical cavity surface emitting lasers) for converting electrical signals into optical signals, photodetectors 44 such as photo diodes for converting optical signals into electrical signals, a driver IC for driving the light emitters 43, and a TIA for converting currents from the photodetectors 44 into voltages. The printed board 40 has terminals 47 for connecting an external device. The printed board 40 is disposed on the lower housing 51.

The optical waveguide 48 is a flexible sheet, one end of which is coupled to the FPC 42.

The optical waveguide 48 is coupled to the lens ferrule 10. The clip 30 has two screw holes 31, into which screws 53 are inserted and mounted to screw holes 51a of the lower housing 51. The lens ferrule 10 and the MT ferrule 20 are fastened to the lower housing 51 via the clip 30.

Sleeves 61a and 61b are fastened to the optical cable 60 with a swage ring 62. Cable boots 71 and 72 covers the optical cable 60 and the sleeves 61a and 62b fastened thereto, respectively. A pull-tab 73 is then attached.

The upper housing 52 is placed on the lower housing 51 to cover the lens ferrule 10 and the MT ferrule 20 fastened with the clip 30 and the printed board 40 disposed on the lower housing 51. The screw holes 52a and screw holes 51b of the lower housing 51 are fastened to each other with screws 54.

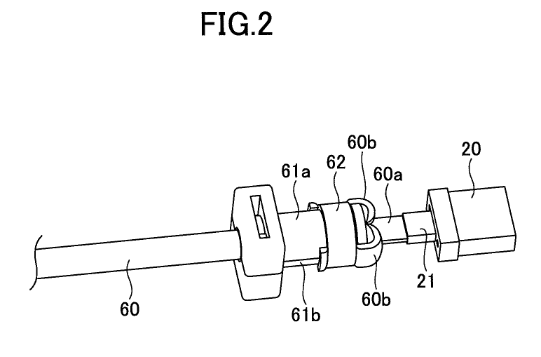

FIG. 2 is a drawing illustrating the connection point between the optical cable 60 and the MT ferrule 20. The optical cable 60 has optical fibers 60a, which are situated at the center and covered with a cover and tensile strength member 60b (collectively referred to as “Cover”). At the connection point at which the MT ferrule 20 is to be connected, the Cover is removed to expose the optical fibers 60a, which are then coupled to the MT ferrule 20. A boot 21 covers the optical fibers 60a connected to the MT ferrule 20. In FIG. 2, horizontally aligned optical fibers 60a are illustrated as one solid mass. The optical module illustrated in FIG. 1 has minor details which differ from those illustrated in FIG. 2 for the sake of convenience of illustration.

As illustrated in FIG. 2, the removed Cover is folded at the end of the sleeves 61a and 61b facing the MT ferrule 20. The Cover is fastened with the ring 62 such that the Cover is sandwiched between the sleeves 61a and 61b and the ring 62.

The tensile strength member 60b is made of aramid fibers or the like. The cover is made of PVC, so that the cover may contract upon application of heat. The Cover is simply placed around the outer surface of the optical fibers 60a. As the cover contracts, thus, the Cover around the optical fibers 60a shifts relative to the optical fibers 60a, thereby also causing the sleeves 61a and 61b and the ring 62 fastened to the Cover to move to the left, in the same direction as the direction of cover contraction. As a result, the length of the exposed portion of the optical fibers 60a is elongated.

Either the sleeves 61a and 61b or the ring 62 is fixedly mounted to the cable boots 71 and 72, and the MT ferrule 20 is fixedly mounted to the lower housing 51 with the clip 30. A distance between the MT ferrule 20 and either the sleeves 61a and 61b or the ring 62 is kept constant, as the cable boots 71 and 72 are fixedly mounted to the lower housing 51 or to the upper housing 52. Therefore, if the length of the exposed portion of the optical fibers 60a is elongated upon contraction of the cover, load may be imposed on the exposed optical fibers 60a to cause bending or breaking, and may cause optical loss.

### <Connection Support>

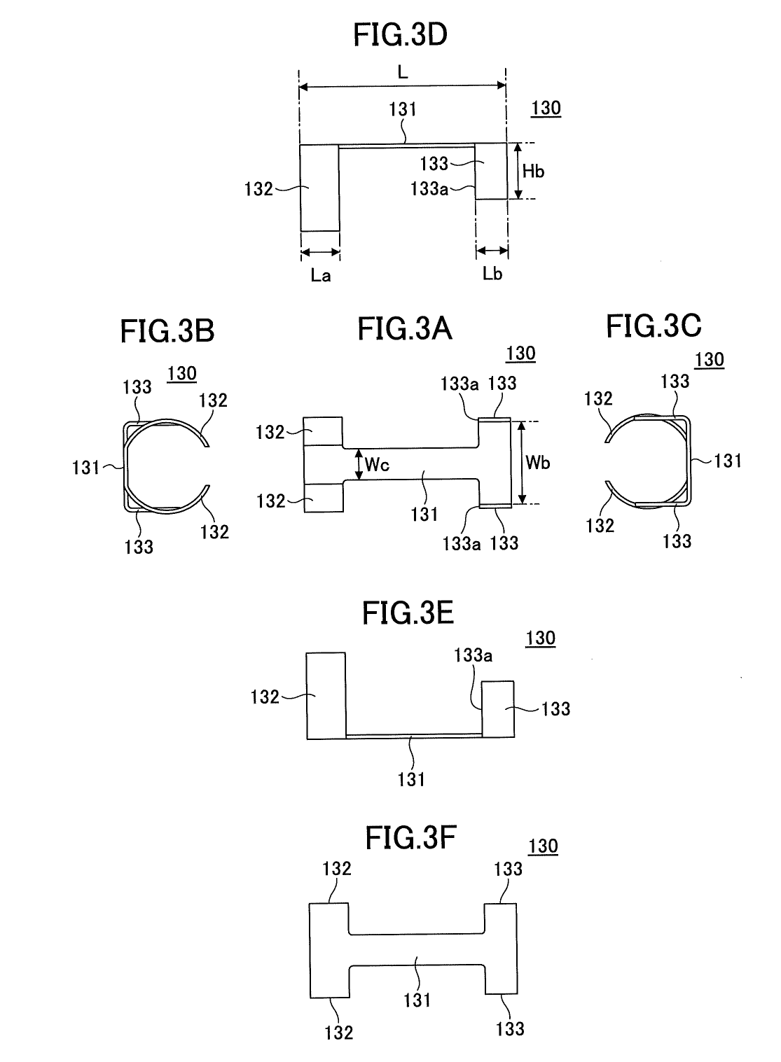

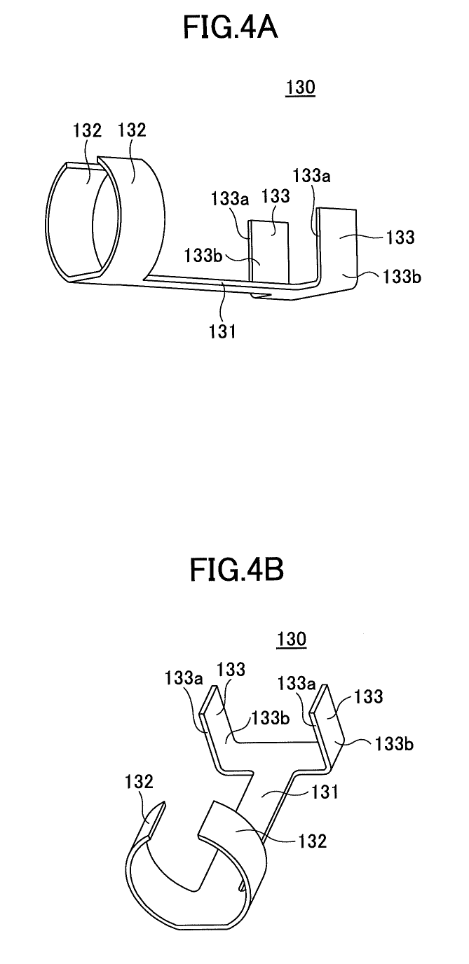

A connection support for optical fibers according to a first embodiment will be described with reference to FIGS. 3A through 3F and FIGS. 4A and 4B. FIG. 3A is a top plan view of a connection support 130 of the present embodiment. FIG. 3B is a front elevation view, FIG. 3C is a back elevation view, FIG. 3D is a left side elevation view, FIG. 3E is a right side elevation view, and FIG. 3F is a bottom plan view of the connection support 130, respectively. FIGS. 4A and 4B are perspective views taken from different angles.

The connection support 130 is formed by bending a metal plate. A cable connector 132 is provided on one side of a support body 131, and a ferrule connector 133 is provided on the other side of the support body 131. The cable connector 132 has two portions extending perpendicularly to the longitudinal direction of the support body 131. The ferrule connector 133 has two bent portions 133b extending perpendicularly to the longitudinal direction of the support body 131. The connection support 130 is stamped out from a stainless plate having a thickness of approximately 0.3 mm, for example, and is then shaped by bending portions thereof.

A length L of the connection support 130 is approximately 81 mm, a length La of the cable connector 132 being approximately 15 mm, a length Lb of the ferrule connector 133 being approximately 12.5 mm, a height Hb being approximately 21.5 mm, a width Wb between two bent portions into which the MT ferrule 20 is inserted being approximately 32 mm, and a width We of the support body 131 at the midsection thereof being approximately 12 mm.

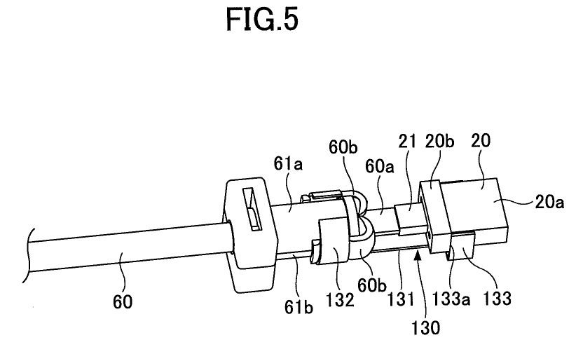

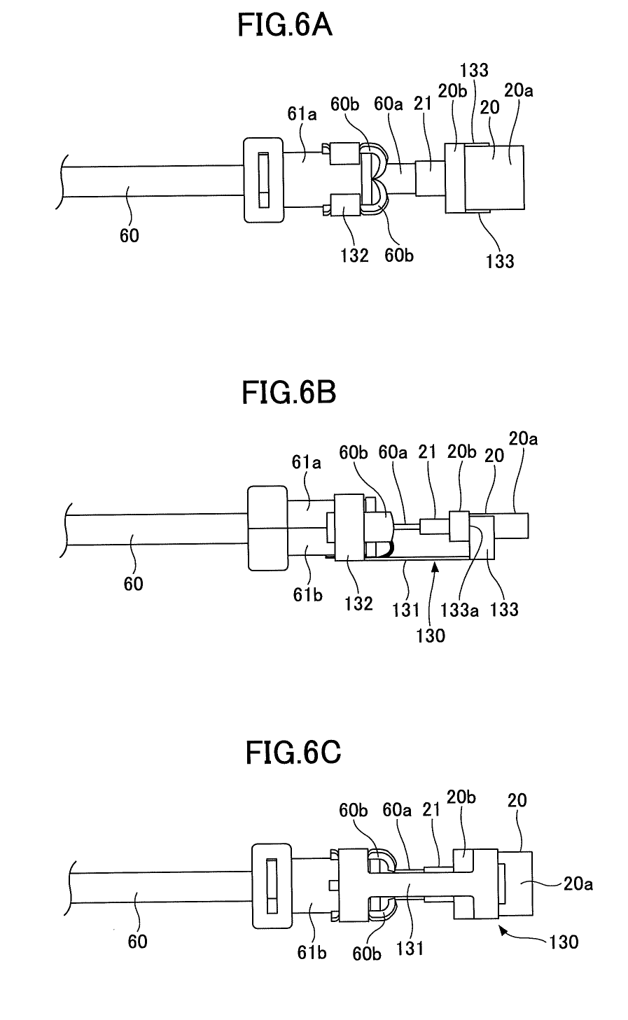

In the following, mounting of the connection support 130 will be described with reference to FIG. 5 and FIGS. 6A through 6C. FIG. 5 is a perspective view of the optical cable 60 and the MT ferrule 20 to which the connection support 130 is mounted. FIG. 6A is a top plan view, FIG. 6B is a side elevation view, and FIG. 6C is a bottom plan view of the optical cable 60 and the MT ferrule 20.

First, mounting of the connection support 130 to the optical cable 60 will be described. The Cover is removed to expose part of the optical fibers 60a. The sleeves 61a and 61b are then attached to the optical cable 60, followed by folding the removed Cover around the sleeves 61a and 61b. Subsequently, the cable connector 132 is bent around the folded Cover so as to fasten the optical cable 60 to the sleeves 61a and 61b. With this arrangement, the sleeves 61a and 61b are placed around the optical cable 60 as a cover, and, also, the Cover is sandwiched and secured between the sleeves 61a and 61b and the cable connector 132. The cable connector 132 is swaged around the outer surfaces of the sleeves 61a and 61b, so that the force applied to bend the cable connector 132 is not transmitted to the optical cable 60 situated inside the sleeves 61a and 61b.

Next, mounting of the connection support 130 to the MT ferrule 20 will be described. As illustrated in FIG. 5 and FIGS. 6A through 6C, the MT ferrule 20 has a wide part 20b having a greater width than a main part 20a at the end thereof to which the optical fibers 60a is connected. As illustrated in FIGS. 3A through 3F and FIGS. 4A and 4B, the ferrule connector 133 is formed by bending two long, narrow extending portions substantially at a right angle. The width of a gap between the two bent portions is approximately the same as the width of the main part 20a.

When mounting the connection support 130 to the MT ferrule 20, the main part 20a is inserted into the gap between the bent portions, and the main part 20a is interposed between the two bent portions. In this state, edges 133a of the ferrule connector 133 facing toward the direction of the optical cable come in contact with the step formed between the main part 20a and the wide part 20b. As a result, the movement of the ferrule connector 133 toward the optical cable 60 is prevented due to the contact between the ferrule connector 133 and the above-noted step. The connection support 130 is thus not detached from the MT ferrule 20 even when the connection support 130 is pulled toward the optical cable 60. Because the cable connector 132 is swaged for secure attachment to the sleeves, the connection support 130 prevents the sleeves 61a and 61b from moving to the left in the drawings when contraction of the cover occurs. The MT ferrule 20 and the optical cable 60 are thus not separated from each other more than a predetermined distance. As the result, the exposed portion of the optical fibers 60a is not elongated, bending or breaking of the optical fibers 60a does not occur, which ensures no occurrence of optical loss. Because the connection support 130 made of metal possesses spring property, the ferrule connector 133 may be configured to elastically clamp the main part 20a. With this arrangement, the main part 20a is fixedly mounted to the ferrule connector 133.

The connection support 130 of the present embodiment is made of metal. Alternatively, the connection support 130 may be made of a resin material or a composite material of metal and resin. When the connection support 130 being made of a composite material of metal and resin, the metal part is formed first, then integrated with resin through insert molding.

### <Optical Module>

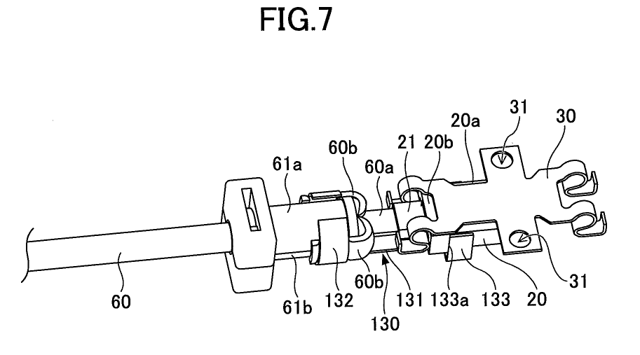

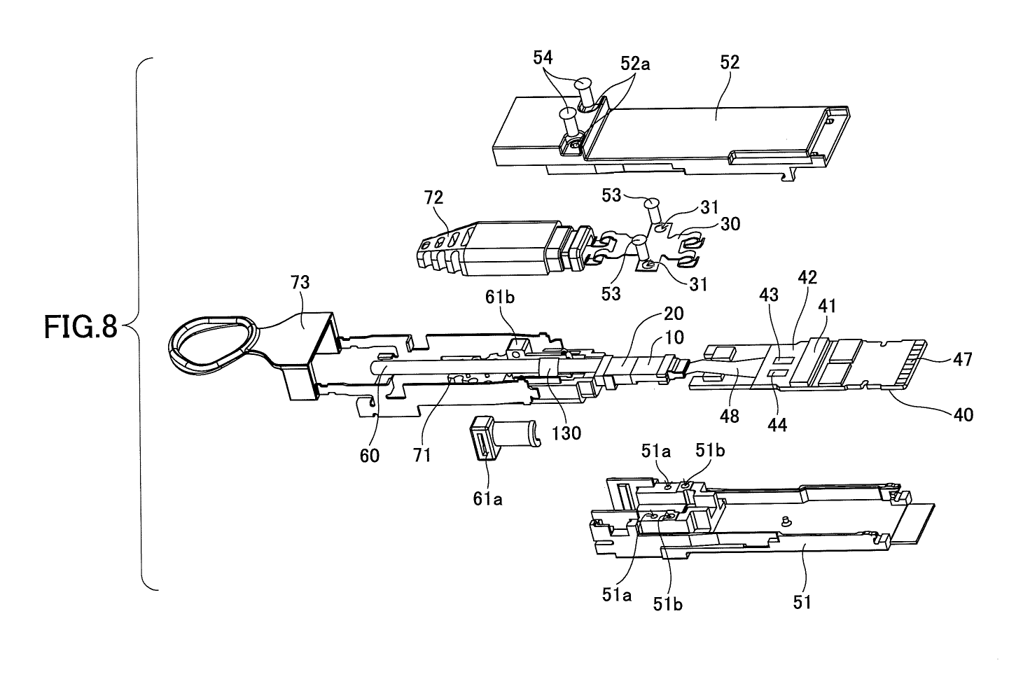

In the present embodiment, the optical cable 60 and the MT ferrule 20 coupled to each other with the connection support 130 illustrated in FIG. 5 and FIGS. 6A through 6C is placed in the housing. Specifically, the lens ferrule 10 and the MT ferrule 20 which are fastened to each other with the clip 30 as illustrated in FIG. 7 are placed inside the housing as illustrated in FIG. 8. FIG. 8 illustrates the optical module according to the present embodiment. Some of the illustrated details may differ from those of the other drawings for the sake of convenience of illustration.

### Second Embodiment

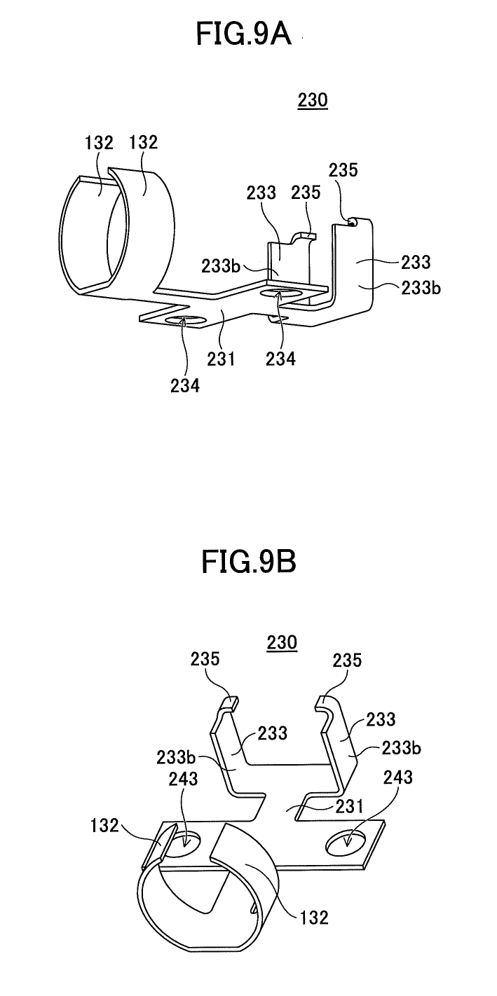

FIGS. 9A and 9B are perspective views of a connection support 230 of the second embodiment as viewed from different angles.

As illustrated in FIGS. 9A and 9B, the connection support 230 is formed by bending a metal plate. A cable connector 132 is provided on one side of the connection support 230, and a ferrule connector 233 is provided on the other side of the connection support 230. Two screw holes 234 are formed in the middle section of a support body 231 for directly attaching the connection support 230 to the housing.

Hocks 235 for preventing the MT ferrule 20 from disengaging are provided on the ends of the ferrule connector 233 in order to ensure secure coupling between the MT ferrule 20 and the ferrule connector 233. The hooks 235 are formed by bending the two ends of the ferrule connector 233 inwardly toward each other.

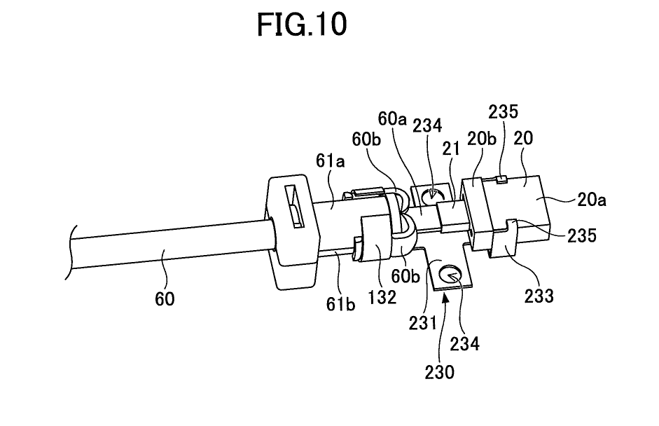

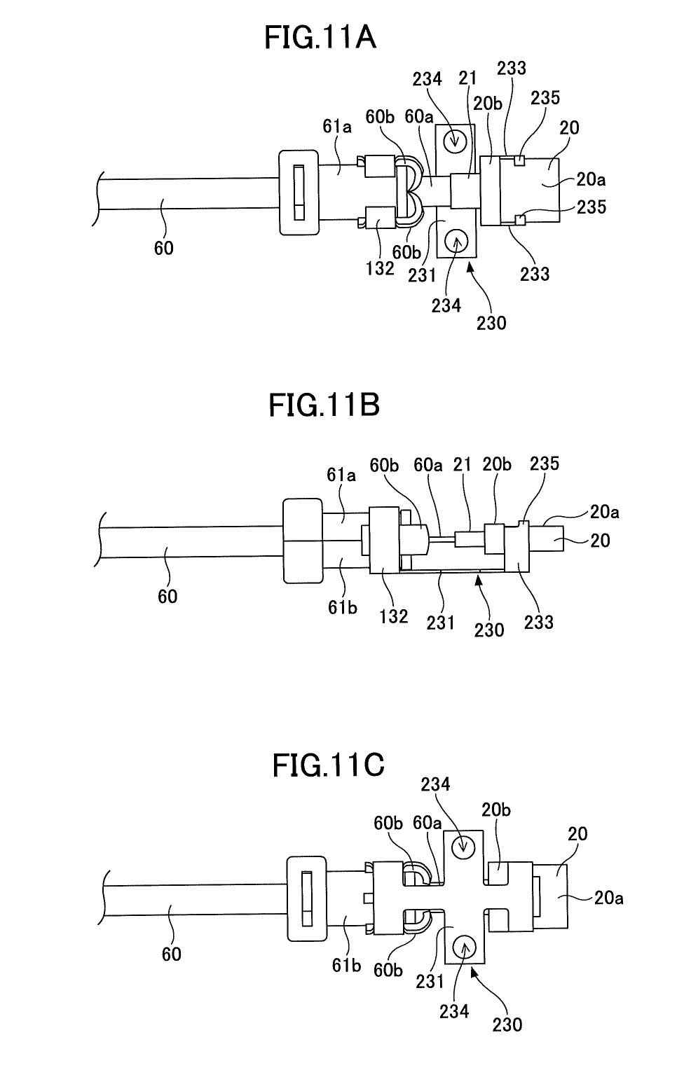

In the following, mounting of the connection support 230 will be described with reference to FIG. 10 and FIGS. 11A through 11C. FIG. 10 is a perspective view of the optical cable 60 and the MT ferrule 20 to which the connection support 230 is mounted. FIG. 11A is a top plan view. FIG. 11B is a side elevation view. FIG. 11C is a bottom plan view. The mounting of the cable connecting 132 to the optical cable 60 is the same as in the first embodiment.

When mounting the connection support 230 to the MT ferrule 20, the main part 20a is inserted between the two bent portions 233b. With this arrangement, the main part 20a is interposed between two bent portions. The hooks 235 provided at the ends of the ferrule connector 233 hold down the upper face of the MT ferrule 20. The MT ferrule 20 is thus supported and fastened by the connection support 230.

According to the present embodiment also, the connection support 230 prevents the movement of the sleeves 61a and 61b even when contraction of the cover occurs, and a distance between the MT ferrule 20 and the sleeves 61a and 61b is kept constant. As a result, the exposed portion of the optical fibers 60a is kept at a predetermined length, and bending or breaking of the optical fibers 60a does not occur, which ensures no occurrence of optical loss.

Other aspects than those described above are the same as or similar to those of the first embodiment.

### Third Embodiment

A third embodiment will be described. The connection support of the present embodiment has an electromagnetic shielding function.

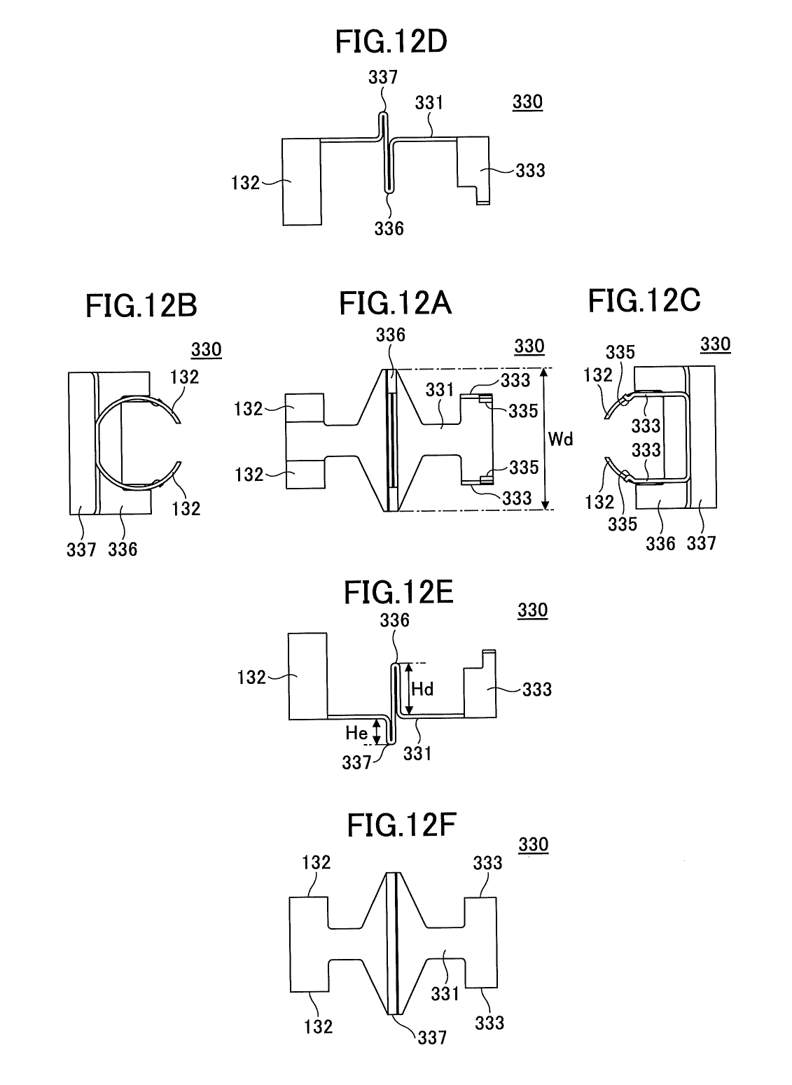

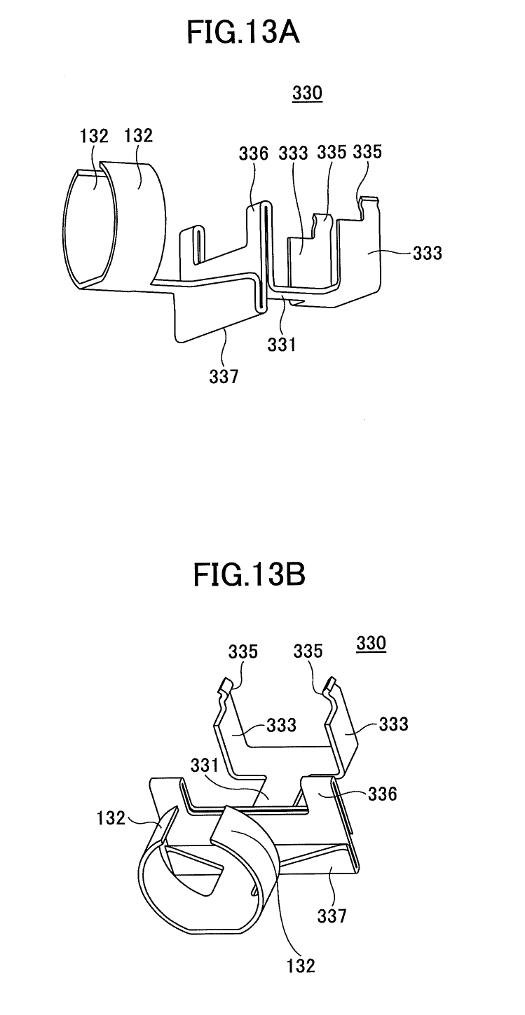

FIG. 12A is a top plan view of a connection support 330 of the present embodiment. FIG. 12B is a front elevation view, FIG. 12C is a back elevation view, FIG. 12D is a left side elevation view, FIG. 12E is a right side elevation view, and FIG. 12F is a bottom plan view of the connection support 330, respectively. FIGS. 13A and 13B are perspective views taken from different angles.

As illustrated in FIGS. 12A through 12F and FIGS. 13A and 13B, the connection support 330 is formed by bending a metal plate. A cable connector 132 is provided on one side of the connection support 330. A ferrule connector 333 is provided on the other side of the connection support 330.

The middle section of a support body 331 has an upper shield 336 and a lower shield 337 formed by folding a metal plate. The upper shield 336 and the lower shield 337 are formed as a folded plate substantially at a right angle to the plane of the support body 331. The upper shield 336 projects upwards from the plane of the support body 331. The lower shield 337 projects downwards from the plane of the support body 331.

An optical module has semiconductor devices and circuit boards, which are situated at the back side of the MT ferrule 20 and generate high-frequency electromagnetic waves. Leakage of high-frequency electromagnetic waves to the outside is not preferable because of an adverse effect on the electronic devices outside the optical module.

It is not easy to install an electromagnetic shielding member at the portion of the optical module where the optical cable 60 is connected because of the presence of the optical cable 60 and the MT ferrule 20. In consideration of this, the connection support 330 is configured to provide an electromagnetic shielding function. The upper shield 336 may have a height Hd of approximately 20 mm, and the lower shield 337 may have a height He of approximately 10 mm. The upper shield 336 and the lower shield 337 have a width Wd of approximately 55 mm.

Snap-fit portions 335 for preventing the MT ferrule 20 from disengaging are provided at the ends of the ferrule connector 333 in order to ensure secure coupling between the MT ferrule 20 and the ferrule connector 333. The snap-fit portions 335 are formed as projections inwardly bulging toward each other. When mounting the ferrule connector 333 to the MT ferrule 20, the MT ferrule 20 is pressed against the snap-fit portions 335 to widen the gap for insertion therein.

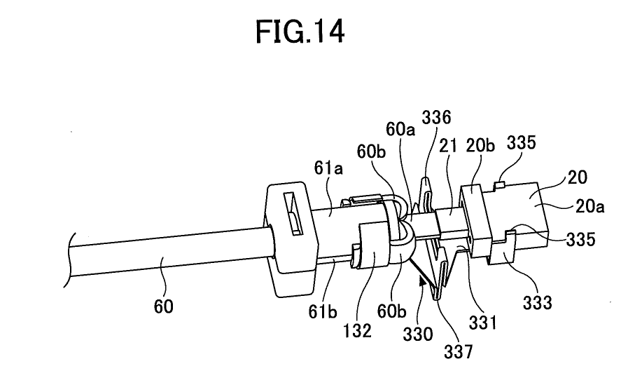

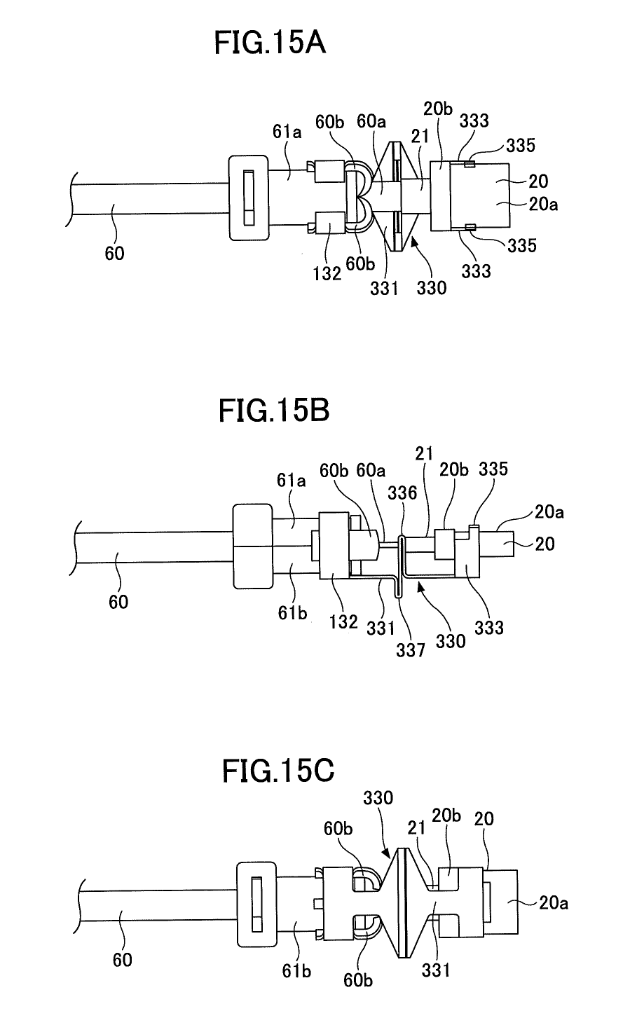

In the following, mounting of the connection support 330 will be described with reference to FIG. 14 and FIGS. 15A through 15C. FIG. 14 is a perspective view of the optical cable 60 and the MT ferrule 20 to which the connection support 330 is mounted. FIG. 15A is a top plan view, FIG. 15B is a side elevation view, and FIG. 15C is a bottom plan view of the optical cable 60 and the MT ferrule 20 to which the connection support 330 is mounted. The mounting of the cable connecting 132 to the optical cable 60 is the same as in the first embodiment.

When mounting the connection support 330 to the MT ferrule 20, the main part 20a is inserted between the two bent portions of the ferrule connecting 333. With this arrangement, the main part 20a is interposed between the bent portions.

The snap-fit portions 335 hold down the upper surface of the MT ferrule 20, so that the MT ferrule 20 is fixedly attached to the connection support 330. Further, edges of the ferrule connector 333 contact with the wide part 20b, so that the movement of the connection support 330 is prevented even when contraction of the cover occurs. The distance between the MT ferrule 20 and the bonding layer 61 is thus kept constant. As a result, the exposed portion of the optical fibers 60a is kept at a predetermined length, and bending or breaking of the optical fibers 60a does not occur, which ensures no occurrence of optical loss.

According to the present embodiment, the upper shield 336 and the lower shield 337 close the gap between the optical cable 60 and the MT ferrule 20 inside the housing. The upper shield 336 and the lower shield 337 shield electromagnetic waves to prevent leaking of electromagnetic waves to optical cable side of the optical module. The shields are formed seamlessly with the connection support 330, and a separate member for shielding electromagnetic waves is not required.

Other aspects than those described above are the same as or similar to those of the first embodiment.

### Fourth Embodiment

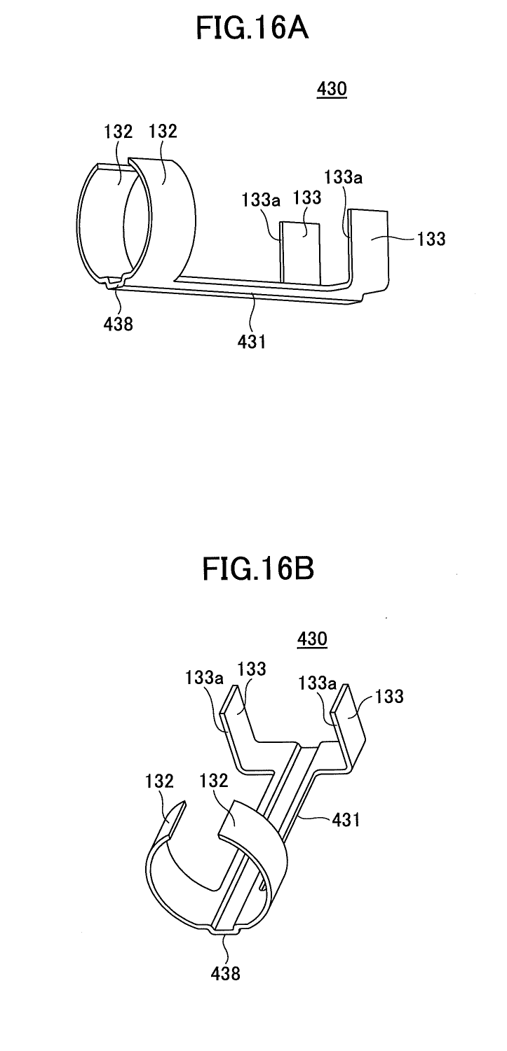

FIGS. 16A and 16B are perspective views of a connection support 430 of the fourth embodiment as viewed from different angles. The connection support of the present embodiment has an increased mechanical strength.

A support body 431 has a fold part 438 which have a rectangular cross-sectional shape with fold lines extending in the longitudinal direction thereof. The provision of the fold part 438 makes the folded portion less likely to bend or fold, thereby increasing the mechanical strength of the connection support 430. Curvature of the optical fibers caused by the bending of the connection support is thus effectively prevented.

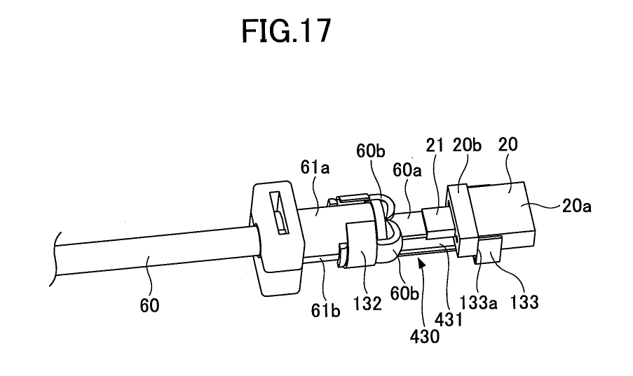

The mounting of the connection support 430 is the same as in the case of the first embodiment. FIG. 17 is a perspective view of the optical cable 60 and the MT ferrule 20 to which the connection support 430 is mounted.

Other aspects than those described above are the same as or similar to those of the first embodiment.

### Fifth Embodiment

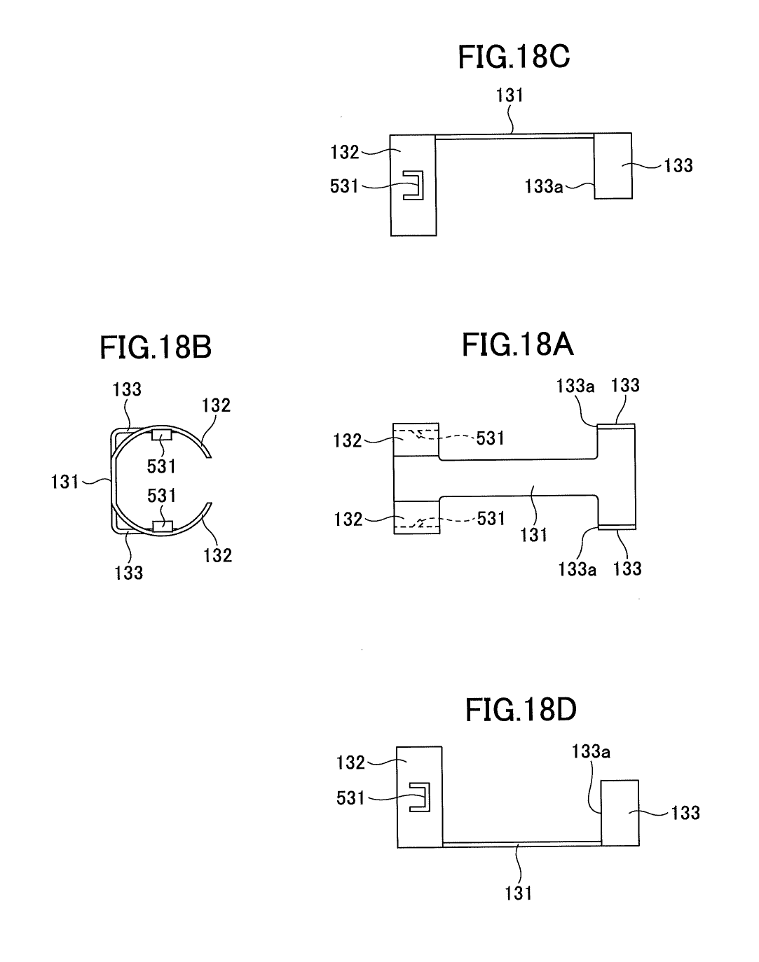

FIG. 18A is a top plan view of the connection support according to the fifth embodiment. FIG. 18B is a front elevation view, FIG. 18C is a left side elevation view, and FIG. 18D is a right side elevation view of the connection support, respectively. The connection support of the present embodiment has projections formed inside the cable connector 132.

As illustrated in FIGS. 18A through 18D, a semi-rectangular portion cut into the plate of the cable connector 132 is bent inwardly to form projections 531 bulging toward the inside of the cable connector 132. The tensile strength member 60b around the sleeves 61a and 61b is stopped by the projections 531, and thus prevented from sliding when the optical cable 60 is pulled. Namely, the tensile strength member 60b fastened around the sleeves 61a and 61b by swaging the cable connector 132 is snagged by the projections 531. The tensile strength member 60b around the sleeves 61a and 61b is not displaced even if the optical cable is pulled. In the present embodiment, the fastening of the cable connector 132 to the sleeves 61a and 61b is made more reliable.

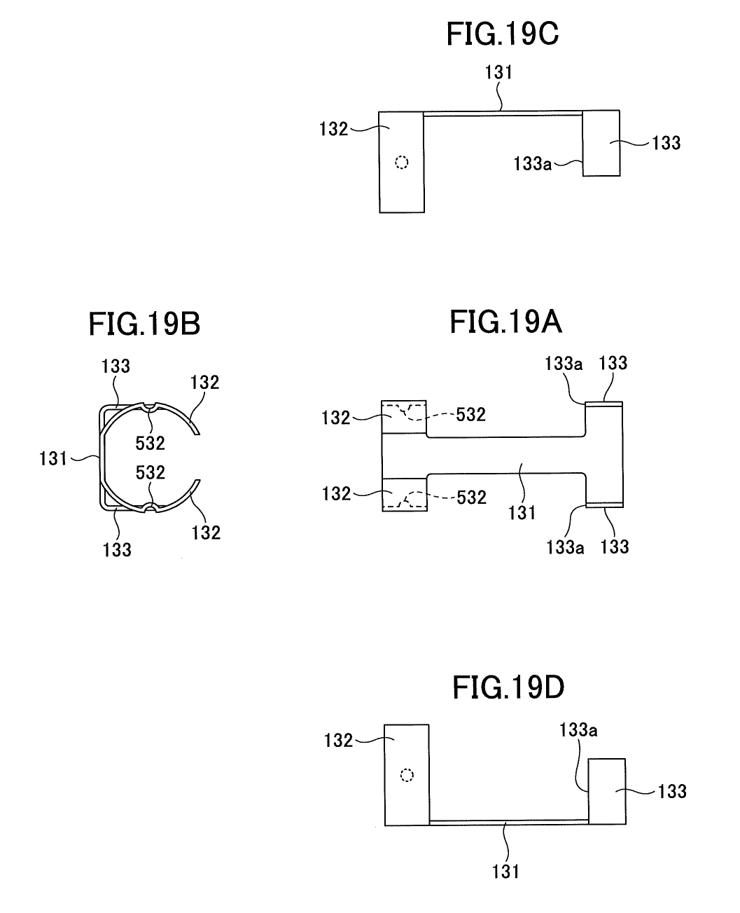

Further, instead of bending a portion cut into a metal plate, projections 532 may be formed inside the metal plate as illustrated in FIG. 19. The projections 532 may be made by deforming respective portions of the cable connecting part 132. FIG. 19A is a top plan view, FIG. 19B is a front elevation view, FIG. 19C is a left side elevation view, and FIG. 19D is a right side elevation view of the connection support, respectively. The feature of the present embodiment is applicable to the first through fourth embodiments.

Further, although a description has been given with respect to one or more embodiments of the present invention, the contents of such a description do not limit the scope of the invention.

The present application is based on and claims the benefit of priority of Japanese priority application No. 2017-069862 filed on Mar. 31, 2017, with the Japanese Patent Office, the entire contents of which are hereby incorporated by reference.

What is claimed is:

1. A connection support, comprising:
a support body;
a cable connector provided at one end of the support body in a longitudinal direction thereof and configured to be mounted to an optical cable; and
a ferrule connector provided at another end of the support body in the longitudinal direction thereof and configured to be mounted to a ferrule,
wherein the cable connector clamps a sleeve covering the optical cable so as to be mounted to the optical cable, and
the ferrule connector has a contact portion placed in contact with the ferrule.

2. The connection support as claimed in claim 1, wherein the ferrule connector has portions extending from the support body and having a spring property, and the ferrule is sandwiched between the extending portions for mounting to the ferrule connector.

3. The connection support as claimed in claim 1, wherein the ferrule connector has portions extending from the support body, and a tip of each of the extending portions has a hook or a snap-fit portion for catching the ferrule, and
wherein the ferrule is sandwiched between the extending portions.

4. The connection support as claimed in claim 1, wherein the support body has a shield plate extending from a midsection thereof to separate space between the cable connector and the ferrule connector.

5. An optical module, comprising:
the connection support of claim 1; and
a ferrule.
